(19) United States
(12) Patent Application Publication
(10) Pub. No.: US 2005/0237448 A1
(43) Pub. Date: Oct. 27, 2005

(54) Color filter and method for manufacturing the same

(75) Inventors: Mei Ling Wu, Miao-Li (TW); Sheng-Shiou Yeh, Miao-Li (TW); Jia-Pang Pang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/111,099

(22) Filed: Apr. 20, 2005

(30) Foreign Application Priority Data
Apr. 23, 2004 (TW) 93111380

(51) Int. Cl. G02F 1/1335

(52) U.S. Cl. 349/106

(57) ABSTRACT

A preferred method for manufacturing a color filter includes the steps of: providing a color filter substrate (60) and forming a black matrix (31) on the substrate by using a patterned mask (21); providing another three patterned masks (23, 25, 27) and respectively forming three kinds of interferential layers (33, 35, 37) for separately displaying red, green and blue. The materials of the deposited films of the preferred method as described are metal-oxide materials, which improve the heat resistance and color reproduction of the color filter. Further, such materials decrease the time needed to perform the entire process, because the thickness and quantity of the deposited films can be readily controlled based on the optical simulation data obtained beforehand.

### FIELD OF THE INVENTION

The present invention relates to a color filter used in devices such as liquid crystal displays and also to a method of manufacturing the color filter, and particularly to a color filter with a three-colored display area formed by a quantity of interferential layers.

### BACKGROUND

Color filters are widely used in liquid crystal display systems to provide RGB (Red Green Blue) primary colors originating from a white light source. Typically, color filters are formed as a continuous film or as an array of pixels. A color filter can include a single color material or multiple color materials (for example, combinations of red, green, and blue). When multiple color materials are used, the color filter is typically formed using pixels in a two dimensional array. Conventional color filter materials are typically composed of organic and organometallic pigments, semiconductors, ceramics, and combinations thereof.

FIGS. 6 to 13 show successive stages in a conventional process for manufacturing a color filter film. The process includes the steps of:
(1) forming a black matrix layer on a substrate, as shown in FIG. 6;
(2) coating a photo resist layer on the black matrix layer, and exposing the photo resist layer to radiation using a pre-patterned photo mask, thereby forming three exposed regions A, B, C that have undergone different amounts of exposure, as shown in FIG. 7;
(3) developing the exposed region A, and consequentially exposing a surface 10 of the substrate below the exposed region A, as shown in FIG. 8;
(4) electroforming a pre-colored dope on the surface 10, the pre-colored dope serving as a first color filter film 101, as shown in FIG. 9;
(5) developing the exposed region B, and consequentially exposing a surface 11 of the substrate below the exposed region B, as shown in FIG. 10;
(6) electroforming a pre-colored dope on the surface 11, the pre-colored dope serving as a first color filter film 111, as shown in FIG. 11;
(7) developing the exposed region C, and consequentially exposing a surface 12 of the substrate below the exposed region C, as shown in FIG. 12; and
(8) electroforming a pre-colored dope on the surface 12, the pre-colored dope serving as a first color filter film 121, as shown in FIG. 13.

The color filter film is thus formed. The black matrix layer and the color filter film together constitute a color filter.

However, in general, the material of the pre-colored dope used is organic rosin. Organic rosin does not have particularly good heat resistance, and does not necessarily provide good color reproduction. Moreover, the pre-colored dope may even reduce color transmission.

What is needed, therefore, is a color filter that overcomes the above-described deficiencies. What is also needed is a method for manufacturing such color filter.

### SUMMARY

A preferred embodiment provides a method for manufacturing a color filter for having a perfect performance of heat resistance and color reproduction, and decreasing the time of whole process.

A color filter is provided for having a perfect performance of heat resistance and color reproduction.

A preferred method manufacturing a color filter includes the steps of: providing a color filter substrate and forming a black matrix on the substrate by using a patterned mask; providing another three patterned masks and respectively forming three kinds of interferential layers for separately displaying red, green and blue.

In a preferred embodiment, the color filter includes a substrate, a black matrix formed on the substrate, and three kinds of color display areas formed on the substrate, with at least one of the color display area comprising interferential layers.

The materials of the deposited films of the preferred method as described are metal-oxide materials, which improve the heat resistance and color reproduction of the color filter. Further, such materials decrease the time needed to perform the entire process, because the thickness and quantity of the deposited films can be readily controlled based on the optical simulation data obtained beforehand.

Other advantages and novel features of the embodiments will become more apparent from the following detailed description when taken in conjunction with the accompanying drawings.

### BRIEF DESCRIPTION OF THE DRAWINGS

FIG. 1 is a schematic, side cross-sectional view of a black matrix formed on a substrate using a pre-patterned shielding mask in a sputter process, according to a preferred method of the present invention.

FIG. 2 is a schematic, side cross-sectional view of a first interferential layer formed on the substrate of FIG. 1 using another pre-patterned shielding mask in another sputter process, according to the preferred method of the present invention.

FIG. 3 is an enlarged view of a portion of the first interferential layer of FIG. 2.

FIG. 4 is a schematic, side cross-sectional view of a second interferential layer formed on the substrate of FIG. 2 using still another pre-patterned shielding mask in still another sputter process, according to the preferred method of the present invention.

FIG. 5 is a schematic, side cross-sectional view of a third interferential layer formed on the substrate of FIG. 4 using yet another pre-patterned shielding mask in yet another sputter process, according to the preferred method of the present invention.

FIGS. 6 to 13 are schematic, side cross-sectional views of successive stages in a conventional process for manufacturing a color filter film.

### DETAILED DESCRIPTION OF PREFERRED EMBODIMENTS

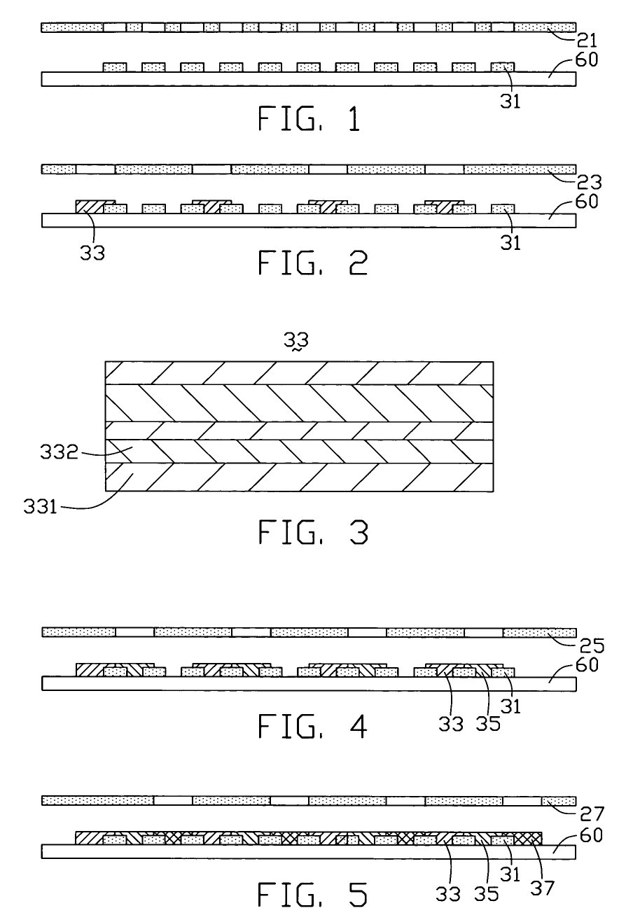

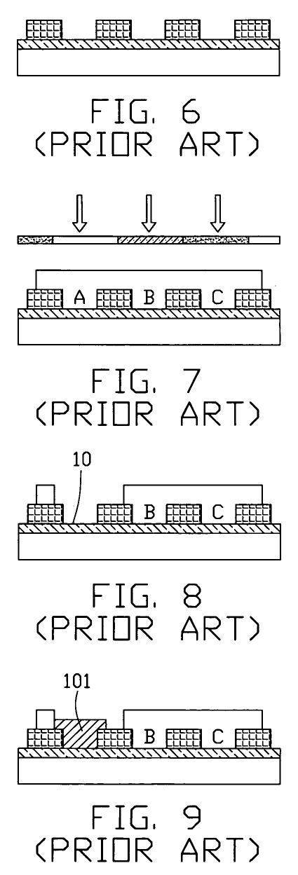

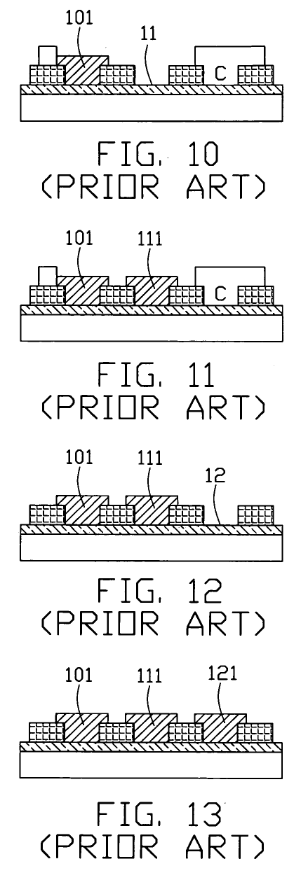

FIGS. 1 to 5 show a preferred method for manufacturing a color filter having interferential layers.

Referring to FIG. 1, a substrate 60 is prepared. The substrate 60 is cleaned in order to remove foreign particles. A pre-patterned shielding mask 21 is located above the substrate 60, and a sputter process is performed in order to form a black matrix 31 on the surface of the substrate 60. A material of the sputter target is chromium (Cr), and a sputter gas used is argon (Ar). The sputter process is performed in air at a pressure of 10×10⁻³ torr.

FIG. 2 shows a plurality of portions of a first interferential layer 33 formed on the substrate 60. FIG. 3 is an enlarged view of any portion of the first interferential layer 33. A pre-patterned shielding mask 23 is located above the substrate 60. A process of repetitious alternate sputtering is performed, thereby forming films 331 and 332 alternately stacked one on the other. In this way, a color filter having the first interferential layer 33 is obtained. A material of the film 331 has a high refractive index, and may for example be titanium dioxide (TiO₂). A material of the film 332 has a low refractive index, and may for example be silicon dioxide (SiO₂). Respective thicknesses of the films 331 and 332 may be different, and can be based on optical simulation data obtained beforehand. Using the interference effect of the films 331 and 332, the first interferential layer 33 can divide light into light-waves of different frequencies in order to display red light-waves only. Thus the first interferential layer 33 can be a red display region of a color filter.

Referring to FIG. 4, another sputter process similar to the sputter process for the red display region is performed. A pre-patterned shielding mask 23 is used to form a plurality of portions of a second interferential layer 35, with the portions of the second interferential layer 35 being adjacent to respective portions of the first interferential layer 33. The second interferential layer 35 can be a green display region of the color filter.

Referring to FIG. 5, a further sputter process similar to the sputter processes for the red and green display regions is performed. A pre-patterned shielding mask 23 is used to form a plurality of portions of a third interferential layer 37, with the portions of the third interferential layer 37 being adjacent to respective portions of the second interferential layer 35. The third interferential layer 37 can be a blue display region of the color filter.

Through the above-described preferred method, the color filter is obtained. However, the method forming the black matrix 31 and the interferential layers 33, 35, 37 can alternatively be evaporation, Physical Vapor Deposition (PVD), or Chemical Vapor Deposition (CVD) such as Plasma Enhanced CVD (PECVD), each such process using an appropriate pre-patterned shielding mask. The material of the black matrix 31 can alternatively be chromium oxide (CrOx). The materials of the films 331 and 332 may be other than TiO₂ and SiO₂, as long as a suitable difference between high and low refractive indexes thereof is configured. For example, the materials of the films 331 and 332 can be niobium pentoxide (Nb₂O₅) and tantalum pentoxide (Ta₂O₅).

A color filter manufactured by the above-described method includes a plurality of pixels defined on the substrate. Each pixel includes three colors display regions, and at least one of the color display regions includes interferential layers.

The materials of the deposited films described are metal-oxide materials, which improve the heat resistance and color reproduction of the color filter. Further, such materials decrease the time needed to perform the entire process, because the thickness and quantity of the deposited films can be readily controlled based on the optical simulation data obtained beforehand.

It is to be understood, however, that even though numerous characteristics and advantages of the embodiments have been set out in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

1. A method for manufacturing a color filter, comprising the steps of:
(a) providing a color filter substrate and forming a black matrix on the substrate by using a patterned mask; and
(b) providing another three patterned masks and respectively forming three kinds of interferential layers for separately displaying red, green and blue.

2. The method for manufacturing the color filter as claimed in claim 1, wherein each patterned mask is a shielding mask, and the black matrix and the three interferential layers are formed by a Physical Vapor Deposition (PVD) method.

3. The method for manufacturing the color filter as claimed in claim 2, wherein the black matrix and the three interferential layers are formed by one or more methods selected from the group consisting of an evaporation method and a sputter method.

4. The method for manufacturing the color filter as claimed in claim 1, wherein the black matrix and the three interferential layers are formed by a Chemical Vapor Deposition (CVD) method.

5. The method for manufacturing the color filter as claimed in claim 4, wherein the black matrix and the interferential layers are formed by a Plasma Enhanced Chemical Vapor Deposition (PECVD) method.

6. The method for manufacturing the color filter as claimed in claim 1, wherein any one or more of the interferential layers respectively comprise a plurality of sub-layers.

7. The method for manufacturing the color filter as claimed in claim 6, wherein the sub-layers are made of inorganic materials.

8. The method for manufacturing the color filter as claimed in claim 7, wherein the sub-layers comprise materials having at least two different refractive indexes.

9. The method for manufacturing the color filter as claimed in claim 7, wherein the sub-layers are made of metal-oxide materials.

10. The method for manufacturing the color filter as claimed in claim 9, wherein the materials of the sub-layers are selected from the group consisting of TiO₂, SiO₂, Nb₂O₅, Ta₂O₅, and any combination thereof.

11. The method for manufacturing the color filter as claimed in claim 10, wherein the materials of the sub-layers comprise Nb₂O₅ and Ta₂O₅.

12. The method for manufacturing the color filter as claimed in claim 8, wherein any one or more of the interferential layers respectively comprise at least five sub-layers.

13. A color filter, comprising:
a substrate;
a black matrix formed on the substrate; and
three kinds of color display areas formed on the substrate, with at least one of the color display areas comprising interferential layers.

14. The color filter as claimed in claim 13, wherein the interferential layers comprise at least five sub-layers.

15. The color filter as claimed in claim 14, wherein the interferential layers comprise materials having at least two different refractive indexes.

16. The color filter as claimed in claim 15, wherein the interferential layers are made of inorganic materials.

17. The color filter as claimed in claim 16, wherein the interferential layers are made of metal-oxide materials.

18. The color filter as claimed in claim 17, wherein the materials are selected from the group consisting of TiO₂, SiO₂, Nb₂O₅, Ta₂O₅, and any combination thereof.

19. The color filter as claimed in claim 18, wherein the materials comprise Nb₂O₅and Ta₂O₅.

20. A color filter, comprising:
a substrate;
a black matrix formed on the substrate; and
a plurality of pixels formed on the substrate, wherein each pixel comprises three colors display regions, and at least one color display region comprises a plurality of interferential layers.

21. The color filter as claimed in claim 20, wherein the interferential layers comprise materials having at least two different refractive indexes.
